(19) United States
(12) Patent Application Publication
(10) Pub. No.: US 2017/0000100 A1
(43) Pub. Date: Jan. 5, 2017

(54) INSECT TRAP

(71) Applicant: BIOGENTS AG, Regensburg (DE)

(72) Inventors: Martin Geier, Regensburg (DE); Andreas Rose, Regensburg (DE)

(21) Appl. No.: 15/190,472

(22) Filed: Jun. 23, 2016

(30) Foreign Application Priority Data
Jun. 30, 2015 (DE) 102015110500.4

(51) Int. Cl. A01M 1/08

(52) U.S. Cl. CPC A01M 1/08

(57) ABSTRACT

The invention applies to an insect trap with a planar or curved, light-colored outflow surface for generating a weak airflow emanating from the outflow surface, with a device for holding, trapping, and/or killing the attracted insects, wherein at least one dark contrast spot is formed on the outflow surface. According to the invention, at least one device for increasing the attraction effect of the insect trap is arranged on the light-colored outflow surface, which device has a dark, sharp, in particular straight edge and/or corner and/or a dark, planar surface arranged at least largely vertically on the outflow surface.

### CLAIM OF PRIORITY

This application claims the benefit of German Application Number DE 10 2015 110 500.4, filed on Jun. 30, 2015, which is incorporated by reference.

### FIELD OF THE INVENTION

The present invention relates to an insect trap.

### BACKGROUND OF THE INVENTION

Blood-sucking insects are major threats to hygiene worldwide because they transmit numerous diseases to humans (for example malaria, yellow fever, dengue fever, and others) and to animals and because they can be exceedingly annoying. One possibility of extensive pest control is the use of insecticides. A further possibility of controlling and fighting harmful insects is the use of trap systems, which are primarily suitable, however, for smaller areas, in particular for enclosed spaces. Insect traps are known in many embodiments and variants. Simple variants include sticky traps, for example, to which attractants are applied for baiting the insects and trapping them after a contact. Other variants emit ultraviolet light or ultrasound and lure the harmful insects in this manner. Also known are apparatuses that give off odorants and attractants, for example by means of an airflow, to ensnare the insects, which are then sucked into a hollow interior space by way of an opposite airflow and held captured inside.

It is furthermore known that visual lures can intensify the attraction effect of traps. EP 1575355 B1 thus describes a combination of olfactory and visual cues to lure the insects. In particular, the described trap has a light-colored diffuser surface with a weak air current emanating from this surface and a dark contrasting surface region arranged within the diffuser surface.

The object of the invention is to raise the attractiveness for insects of such a trap and to thus increase the effectiveness of such a trap.

### SUMMARY OF THE INVENTION

The invention relates to an insect trap with a planar or curved light-colored outflow surface for generating a weak airflow emanating from the outflow surface, with a device for holding, trapping, and/or killing the attracted insects, wherein at least one dark contrast spot is formed within the outflow surface. The extensive, weak, and evenly distributed airflow is attractive to many harmful insects and is capable of attracting them. In order to additionally increase this effect, it can be provided to emit further attractants together with the airflow via the outflow surface.

The device for holding, trapping, and/or killing the attracted insects can, for example, comprise an intake opening for sucking in attracted insects and an associated trap container. The trap container is preferably designed such that the insects captured in it cannot escape from it anymore. As the case may be, the trap container can contain an insecticide so that the insects can be killed within the trap container. In particular, it can be provided that the insect trap or, as the case may be, the trap container has a hollow cylindrical form, a truncated cone form, or a similar form, wherein an end face facing toward the top is designed as outflow surface. As an alternative, it can also be provided that the insect trap is formed to be spherical and, in particular, provided to be hanging.

The device for holding, trapping, and/or killing the attracted insects can, for instance, be formed by a glue layer on the surface of the insect trap, in particular, on the outflow surface and/or on the at least one contrast spot such that the insects remain stuck to the surface. In particular, the glue layer can be combined with an insecticide to kill the insects adhering to it.

According to the invention, it is provided that at least one device for increasing the attraction effect of the insect trap is arranged on the light-colored outflow surface, which device has a sharp, dark, in particular straight edge and/or an, in particular dark corner and/or a dark, planar surface arranged at least largely vertically on the outflow surface. In particular, the device can be designed in such a manner that a sharp, dark, in particular straight edge and/or a dark, planar surface is arranged above the outflow surface.

In this context, the dark planar surface is preferably arranged in a plane that is largely orthogonal to the outflow surface. Surfaces referred to as “largely orthogonal to the outflow surface” are such surfaces as are at an angle between 70 degrees and 110 degrees to the outflow surface, in particular, surfaces at an angle between 80 degrees and 100 degrees to the outflow surface, particularly preferentially between 85 degrees and 95 degrees. If corners are furthermore present, this also increases the attractiveness for the insects. According to one embodiment, two sharp, dark, in particular straight edges are arranged against each other such that a dark corner is formed between them. Two surfaces are arranged, for instance, against each other largely orthogonally to the outflow surface, each at an angle between 70 degrees and 110 degrees to the outflow surface such that an angle between 50 degrees and 130 degrees, particularly preferentially an angle smaller than 90 degrees, is formed between the two surfaces.

This device for increasing the attraction effect can, in particular, be arranged on the light-colored outflow surface in addition to the at least one contrast spot. Alternatively, the at least one contrast spot can in itself be designed such that the contrast spot itself has a sharp, dark, in particular straight edge and/or corner and/or a dark, planar surface arranged at least largely vertically on the outflow surface.

Experiments have shown, in particular, that for a trap according to EP 1575355 B1, the catch rate is verifiably improved by the presence of an additional sharp, dark, in particular straight edge above the light-colored outflow surface and/or of an, in particular dark corner and/or of a dark, planar surface arranged at least largely vertically on the outflow surface.

According to one embodiment of the invention, the at least one sharp, dark, in particular straight contrast spot is designed as a dark intake duct and the device with the sharp, dark, in particular straight edge is arranged to be adjacent to the intake duct on the light-colored outflow surface. Preferably, the sharp, dark, in particular straight edge is in this instance arranged at a specified spacing above the light-colored outflow surface. It can be provided, for example, that the sharp, dark, in particular straight edge is arranged at approximately the same height above the intake surface as the intake opening of an intake pipe described in EP 1575355 B1. According to an alternative embodiment, it is provided that the sharp, dark, in particular straight edge is arranged above the intake opening of an intake pipe above the intake surface as described in EP 1575355 B1.

According to one embodiment, the device is formed by a dark surface, which is arranged largely vertically on the light-colored outflow surface, which is arranged at least largely horizontally, and which, in particular, has an upper sharp, straight edge, which runs at least largely parallel to the light-colored outflow surface. If the light-colored outflow opening is curved, it can be provided that the upper, sharp, dark edge is correspondingly curved.

The device for increasing the attraction effect of the insect trap is formed by a dark sheet metal plate or the like, for example. The outflow surface has a slot or a similar recess into which the sheet metal can be inserted such that the sheet metal plate stands largely perpendicular on the outflow surface. Such a construction is particularly simple and can be easily disassembled into its individual parts and packaged in a space-saving manner for transport.

If the at least one contrast spot is formed by a dark intake pipe, it is preferably provided that the dark sheet metal plate is arranged on the outflow surface such that one of the lateral faces is arranged largely orthogonally to the outflow surface and faces toward the intake pipe.

According to one embodiment, the device for increasing the attraction effect of the insect trap is designed to be cube-shaped and the at least one lateral face of the cuboid, which lateral face faces the intake duct, has a dark outer surface. The device is formed by a cube-shaped box, for example, which is fastened to the outflow surface such that a dark lateral face with a dark, sharp, upper edge faces toward the intake pipe. The remaining lateral faces can have the same light color, for example, or, as the case may be, the same shade of color as the outflow surface. According to an alternative embodiment, it is provided that all outer surfaces of the cuboid are dark, and only the one lateral face on the side of the cuboid that is averted from the intake pipe has the same light color or, as the case may be, the same shade of color as the outflow surface.

According to a further embodiment it is provided that the at least one intake duct forming a contrast spot is not formed to be tubular—as described in EP 1575355 B1—but that the intake duct rather has a polygonal cross section and forms the device for increasing the attraction effect of the insect trap. In particular, the intake duct has a polygonal cross section in a plane parallel to the intake surface and above the intake surface. In this embodiment, the intake duct, in particular, has a plurality of dark corners, which further additionally increase the attraction effect of the dark contrast spot.

According to a further embodiment of such an intake duct, it is provided that a first lateral face of the intake duct is arranged to be largely orthogonal on the outflow surface and that a second lateral face of the intake duct, which second lateral face is located largely opposite, is also arranged to be largely orthogonal on the outflow surface. That is to say that in an erected insect trap, the outflow surface is preferably aligned to be largely horizontal and the lateral faces of the intake duct with a polygonal cross section are arranged in vertical planes.

It can furthermore be provided that the first and the second lateral face each have different heights such that the intake opening, which is delimited by the upper sides of the lateral faces, is in a plane, which forms an angle with the plane of the light-colored outflow surface. That is to say that in an erected insect trap in which the outflow surface is preferably aligned to be largely horizontal, the sides delimiting the intake opening define a so-called inclined plane, which is inclined in relation to the outflow surface or, as the case may be, in relation to the horizontal. According to a further embodiment of the invention, the lateral face with the greater height has a sharp, dark, in particular straight edge and the inner side of the lateral face with the greater height has a dark color, which is, in particular, darker than the inner side of the shorter lateral face.

### DESCRIPTION OF FIGURES

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged in relation to other elements to facilitate an understanding of the invention.

FIG. 1 shows a known insect trap according to the prior art.

FIG. 2 shows a first embodiment of an insect trap according to the invention.

FIG. 3 shows a second embodiment of an insect trap according to the invention.

FIG. 4 compares the catch rate of an insect trap according to the known prior art of FIG. 1 with the catch rates of the insect traps according to the invention as shown in the FIGS. 2 and 3.

### DETAILED DESCRIPTION OF THE INVENTION

The same or equivalent elements of the invention are designated by identical reference characters. Furthermore and for the sake of clarity, only the reference characters relevant for describing the respective figure are provided. It should be understood that the detailed description and specific examples of the embodiments of the apparatus or of the method according to the invention are intended for purposes of illustration only and are not intended to limit the scope of the invention.

FIG. 1 shows a known insect trap 1 according to the prior art. The insect trap 1 comprises an approximately hollow cylindrical collection container 2 for accommodating the attracted and captured insects. Arranged as a top cover on the collection container 2 is a planar or, as the case may be, a slightly curved, light-colored outflow surface 3. A weak, even, upwardly directed airflow 4 emanates therefrom. This extensive, weak, even airflow 4 is particularly luring for many insects, in particular for mosquitoes or the like. The airflow 4 at a flow velocity S4 is generated by at least one air blower 5, for example, which is arranged below the outflow surface 3. Furthermore, the effect of the airflow 4 can be intensified by warmth and/or by addition of further attractants, in particular of chemical attractants.

The outflow surface 3 can additionally be provided with a glue and/or an insecticide such that insects which land on the outflow surface 3 are immediately trapped and/or killed.

Moreover provided is an intake duct 6. In the illustrated exemplary embodiment, this intake duct 6 is, in particular, formed as a dark contrast spot 7 on the outflow surface 3. The intake duct 6 is used, for example, for suctioning in ambient air 8 at a flow velocity S8. In this instance, the flow velocity S8 of the ambient air 8 intake is significantly higher than the flow velocity S4 of the airflow 4 emanating via the outflow surface 3. In particular, it can be provided that only one single air blower 5 is used for the intake of the ambient air 8 and for generating the emanating airflow 4.

For the purpose of better illustrating the three-dimensionality and, in particular, the form of the intake duct 6, the upper edge of the intake opening 9 is indicated by a dotted line. The illustration, however, gives no indication of the color design of the edge. Preferably, this edge is also dark and, in particular, forms no contrast with the remaining intake duct 6.

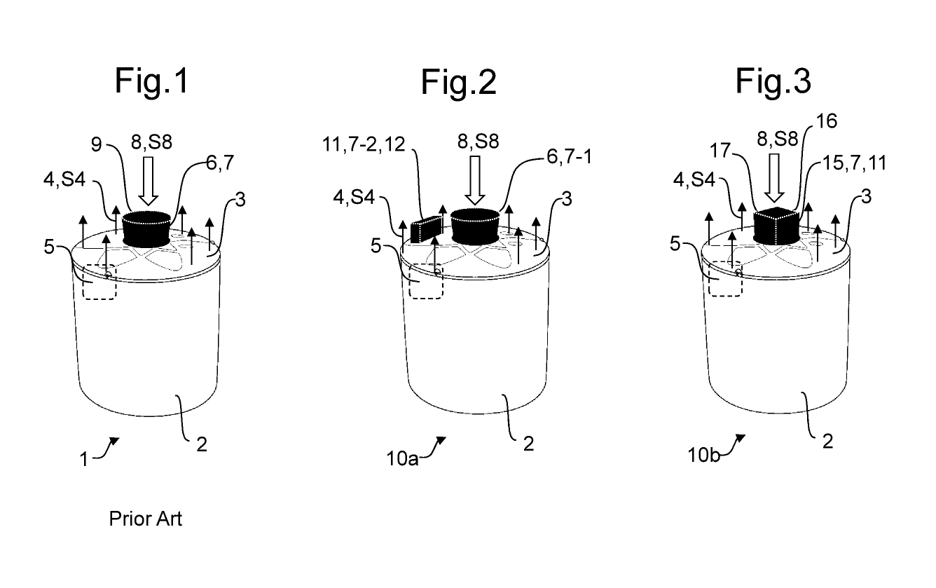

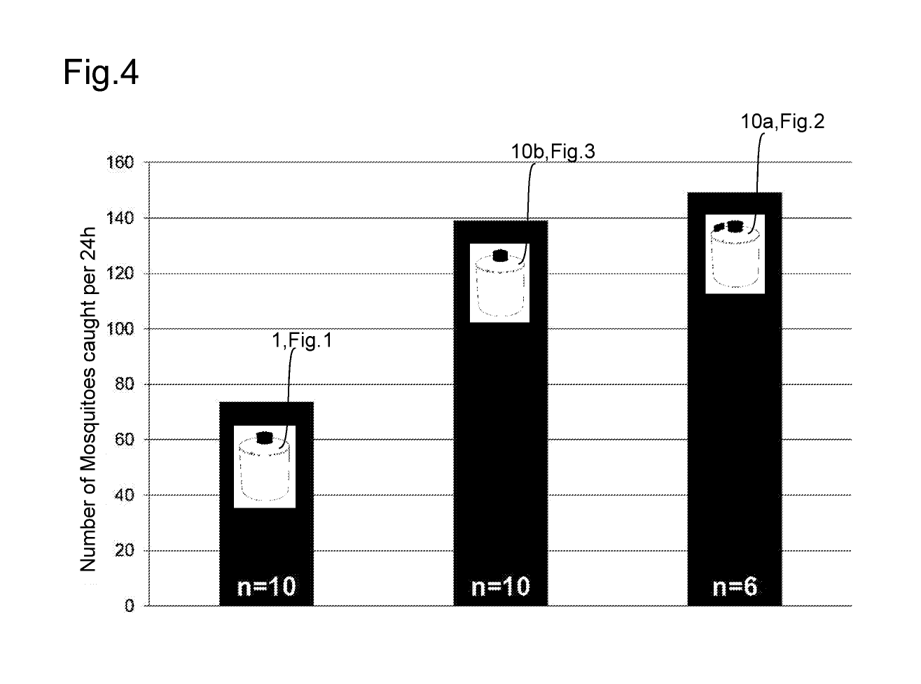

FIG. 2 shows a first embodiment of an insect trap 10a according to the invention with a device 11 for increasing the attraction effect of the insect trap 10a. The insect trap 10a has an intake duct 6, which is formed as a first contrast spot 7-1 with a circular intake opening 9, as is known from the prior art. Furthermore, the insect trap 10a has a device 11 formed as a second contrast spot 7-2 for intensifying the attraction effect. In the illustrated exemplary embodiment, the device 11 is, for instance, cube-shaped and has dark, straight edges and an outer surface that is dark on all sides. In particular, the device 11 is formed by a black cuboid 12, which is arranged on the outflow surface 3, adjacent to the intake duct 6.

According to an alternative embodiment, which is not illustrated here, the cube-shaped device can have differently colored outer surfaces, where, in particular, the outer surface facing the intake duct 6 is designed to be dark and, in particular, delimited by dark sides with sharp, straight edges.

For the purpose of better illustrating the three-dimensionality and, in particular, the form of the intake duct 6 and of the device 11, the upper edge of the intake opening 9 and the sharp, straight edges of the device 11 are indicated by a dotted line. The illustration, however, gives no indication of the color design of the edges. Preferably, these edges are also dark and, in particular, form no contrast with the remaining intake duct 6 or, as the case may be, with the device 11.

FIG. 3 shows a second embodiment of an insect trap according to the invention 10b. This insect trap 10b has an intake duct 15 with a square cross section. In particular, the intake duct 15 forms both a contrast spot 7 and a device 11 for increasing the attraction effect. The dark, straight, upper edges 16 of the square intake opening 17, in particular, cause an increased attractiveness in comparison with a circular intake opening 9 according to the prior art from FIG. 1.

For the purpose of better illustrating the three-dimensionality and, in particular, the form of the intake duct 6, the edges of the intake duct 6 are indicated by a dotted line. The illustration, however, gives no indication of the color design of the edges. Preferably, these edges are also dark and, in particular, form no contrast with the remaining intake duct 6.

FIG. 4 compares the catch rate of an insect trap 1 according to the known prior art of FIG. 1 with the catch rates of the insect traps 10a, 10b according to the invention as shown in the FIGS. 2 and 3.

The experiments were conducted as field trials according to the following trial protocol: An insect trap of each type 1, 10a, 10b is erected in a trial area. In this context, two adjacent insect traps 1, 10a, 10b are spaced at least 30 meters apart. After a time period of 24 hours, the insect traps 1, 10a, 10b are emptied and the captured insects are counted. It is additionally possible to group and determine the various types of attracted insects.

The positions of the insect traps 1, 10a, 10b are subsequently rotated daily. That is to say that each insect trap is tested for a period of time of 24 hours in each position. When a complete rotation has been carried out, that is, when each insect trap 1, 10a, 10b has been in each trial position once, a new cycle of trials is started over again. This experimental set-up is also referred to as Latin square trial design. The number “n” relates to the number of trial days or, as the case may be, of repeat trials. Then, the average numbers of the captured insects are calculated. In this manner, position effects and time effects are averaged out. The different numbers for “n” result from the fact that it was not possible to evaluate all trial days for each type of trap, for instance, because the power supply for the corresponding trap had been temporarily interrupted, thus resulting in changed trial conditions such that it was not possible to compare the results.

The graphic illustration of FIG. 4 in each case shows the averaged number of captured mosquitoes in a period of time of 24 hours for each insect trap 1, 10b, 10a. While on average only approximately 75 mosquitoes were caught in a 24-hour period of time using an insect trap as known from the prior art according to FIG. 1, it was possible to capture 140 mosquitoes using an insect trap 10b according to FIG. 3 with an intake duct 15 with an angular cross section 17 in a period of time of almost 24 hours, and even approximately 150 mosquitoes using an insect trap 10a with an additional device 11 adjacent to the intake duct 6 according to FIG. 2 in a 24-hour period of time.

The trials thus show that the presence of a device for increasing the attraction effect of the insect trap, which has a dark, sharp, in particular straight edge and/or a dark, planar surface arranged at least largely vertically on the outflow surface, results in a significant increase of the attractiveness of the insect trap 10a, 10b. In this context it is largely irrelevant whether the intake duct itself is constructed such that it has a dark, sharp, in particular straight edge and/or a dark, planar surface arranged at least largely vertically on the outflow surface or whether the device for increasing the attraction effect of the insect trap is additionally arranged on the outflow surface.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

### LIST OF REFERENCE CHARACTERS

1 Insect trap
2 Collection container
3 Outflow surface
4 Airflow
5 Air blower
6 Intake duct
7 Contrast spot
8 Ambient air
9 Circular intake opening
10 Insect trap
11 Device for increasing the attraction effect
12 Cuboid
15 Intake duct
16 Dark, straight edge
17 Square intake opening
S Flow velocity

We claim:

1. An insect trap (1, 10) for generating a weak airflow (4) emanating from the outflow surface (3), comprising:
a device for holding, trapping, and/or killing the attracted insects with a planar or curved, light-colored outflow surface (3), wherein at least one dark contrast spot (7) is formed on the outflow surface (3), and
at least one attraction device (11) for increasing an attraction effect of the insect trap that is arranged on the light-colored outflow surface (3), where the attraction device (11) has a dark, sharp, straight edge (16) and/or corner and/or a dark, planar surface arranged at least largely vertically on the outflow surface.

2. The insect trap (1, 10) of claim 1 wherein at least one dark contrast spot (7) is a dark intake duct (6), and wherein the attraction device (11) is arranged to be adjacent to the intake duct (6) on the light-colored outflow surface (3).

3. The insect trap (1, 10) of claim 2, wherein the attraction device (11) is formed by a dark surface, which is arranged largely perpendicular to the light-colored outflow surface (3) and which has an upper sharp, straight edge, which is arranged at least largely parallel to the light-colored outflow surface (3).

4. The insect trap (1, 10) of claim 2, wherein the device (11) is cube-shaped, wherein at least one lateral face of the cuboid faces the intake duct (6) and has a dark outer surface.

5. The insect trap (1, 10) of claim 1 wherein the at least one dark contrast spot (7) is a dark intake duct (15) and wherein the intake duct (15) has a polygonal cross section and forms the attraction device (11) for increasing the attraction effect of the insect trap.

6. The insect trap (1, 10) of claim 5 wherein the intake duct (15) comprises a first and a second lateral face with the first lateral face having a height greater than the second lateral face wherein the lateral faces are located opposite each other.

7. The insect trap (1, 10) of claim 6, wherein at least the inner sides of the first and second lateral faces are dark.

8. The insect trap (1, 10) of claim 6 wherein the inner sides of the first and second lateral faces are each a different dark shade.

9. The insect trap (1, 10) of claim 8 wherein the inner sides of the first lateral face is darker than the inner sides of the second lateral face.

10. The insect trap (1, 10) of claim 7 wherein the inner sides of the first and second lateral faces are each a different dark shade.

11. The insect trap (1, 10) of claim 8 wherein the inner sides of the first lateral face is darker than the inner sides of the second lateral face.
